(19) United States
(12) Patent Application Publication
(10) Pub. No.: US 2009/0002830 A1
(43) Pub. Date: Jan. 1, 2009

(54) Dichroic Filter

(75) Inventor: Mikio Okamoto, Kanagawa-ken (JP)

Correspondence Address: OLIFF & BERRIDGE, PLC, P.O. BOX 320850, ALEXANDRIA, VA, 22320-4850, US

(73) Assignee: NIKON CORPORATION, Chiyoda--ku (JP)

(21) Appl. No.: 12/224,134

(22) PCT Filed: Feb. 7, 2007
(86) PCT No.: PCT/JP2007/052136

§ 371 Date: Aug. 25, 2008

(30) Foreign Application Priority Data
Feb. 27, 2006 (JP) 2006-049718

(51) Int. Cl. G02B 5/28

(52) U.S. Cl. 359/589

(57) ABSTRACT

A first multilayer film filter 2 is formed on one side of a transparent substrate 1, e.g., glass, and a second multilayer film filter 3 is formed on the other side. The multilayer film filter 2 is a low pass filter, and the multilayer film filter 3 is a high pass filter. Furthermore, the multilayer films are designed so that a shift in spectral transmittance characteristics produced by changes in incident angle is larger for the multilayer film filter 2 than for the multilayer film filter 3. Thereby, even if light of a wavelength that should be blocked is transmitted due to the shift in the spectral transmittance characteristics of the multilayer film filter 2, the transmittance of light of that wavelength is blocked because of the shift in the spectral transmittance characteristics of the multilayer film filter 3. Thereby, the dichroic filter transmits a significantly reduced percentage of stray light that impinges at large incident angles.

### FIELD OF THE INVENTION

The present invention relates to a dichroic filter.

### RELATED ART

Dichroic filters are used in the field of, for example, optical communications for the purpose of transmitting light of a first wavelength and reflecting (without transmitting) light of a second wavelength. For example, with a dichroic filter that is designed to, for example, transmit light with a wavelength of 1,560 nm and reflect (without transmitting) light with a wavelength of 1,310 nm, the 1,560 nm light that emerges from an optical fiber enters the dichroic filter perpendicularly and transmits therethrough, and the 1,310 nm light that emerges from a separate light source is reflected by the same dichroic filter and enters the optical fiber.

In an optical system of the type discussed above, the 1,560 nm light enters the dichroic filter perpendicularly and is transmitted therethrough with high transmittance, and therefore the amount of the stray light is small, which makes it unnecessary to give significant consideration thereto. However, the 1,310 nm light impinges the dichroic filter at a prescribed angle and is reflected thereby, and that reflected light becomes stray light in the optical system and may reenter the dichroic filter at a large incident angle.

Generally, with a filter that is formed from a multilayer film (a multilayer film in the present specification and claims means a film that is provided with prescribed optical characteristics by alternately superposing layers of a high refractive substance and a low-refractive-index substance), it is known that spectral transmittance characteristics shift to the short wavelength side (the high frequency side) as the incident angle increases.

For example, FIG. 8 shows the spectral transmittance characteristics of a high pass filter that comprises a multilayer film that has a film configuration (of the type shown in Table 1) formed on glass. It can be seen that the transmittance of the 1,310 nm light is maintained at substantially 0% up to an incident angle of 40°, but approaches 40% at an incident angle of 60° or greater. Furthermore, in Table 1, n is the refractive index, nm is the film thickness, and nd is the optical film thickness (nm); these assignments apply likewise to subsequent tables below. In addition, in FIG. 8 and FIG. 9, the abscissa is the wavelength (nm).

TABLE 1

| Layer Substance | n | nm | nd |
|---|---|---|---|
| air | 1 | | |
| Nb₂O₅ | 2.22 | 74.15 | 164.613 |
| SiO₂ | 1.45 | 226.79 | 328.8455 |
| Nb₂O₅ | 2.22 | 148.3 | 329.226 |
| SiO₂ | 1.45 | 226.79 | 328.8455 |
| Nb₂O₅ | 2.22 | 148.3 | 329.226 |
| SiO₂ | 1.45 | 226.79 | 328.8455 |
| Nb₂O₅ | 2.22 | 148.3 | 329.226 |
| SiO₂ | 1.45 | 226.79 | 328.8455 |
| Nb₂O₅ | 2.22 | 148.3 | 329.226 |
| SiO₂ | 1.45 | 226.79 | 328.8455 |
| Nb₂O₅ | 2.22 | 148.3 | 329.226 |
| SiO₂ | 1.45 | 226.79 | 328.8455 |
| Nb₂O₅ | 2.22 | 148.3 | 329.226 |
| SiO₂ | 1.45 | 226.79 | 328.8455 |
| Nb₂O₅ | 2.22 | 148.3 | 329.226 |
| SiO₂ | 1.45 | 226.79 | 328.8455 |
| Nb₂O₅ | 2.22 | 148.3 | 329.226 |
| SiO₂ | 1.45 | 226.79 | 328.8455 |
| Nb₂O₅ | 2.22 | 148.3 | 329.226 |
| SiO₂ | 1.45 | 226.79 | 328.8455 |
| Nb₂O₅ | 2.22 | 148.3 | 329.226 |
| SiO₂ | 1.45 | 226.79 | 328.8455 |
| Nb₂O₅ | 2.22 | 148.3 | 329.226 |
| SiO₂ | 1.45 | 226.79 | 328.8455 |
| Nb₂O₅ | 2.22 | 148.3 | 329.226 |
| SiO₂ | 1.45 | 226.79 | 328.8455 |
| Nb₂O₅ | 2.22 | 74.15 | 164.613 |
| glass | 1.56 | | |

Generally, such a filter is designed so that the ratio of the optical film thickness of the high-refractive-index substance to the optical film thickness of the low-refractive-index substance is substantially 1:1. In contrast, the inventors discovered that the wavelength shift discussed above was reduced to a certain extent when the ratio of the optical film thickness of the high-refractive-index substance to the optical film thickness of the low-refractive-index substance was 2:1 or greater and that, as a result, the change in characteristics was small even in the case of oblique incident angles; accordingly, the inventors created an invention based on these findings. This invention is disclosed in Japanese Unexamined Patent Application Publication No. H11-101913 (Patent Document 1).

### Patent Document 1

Japanese Unexamined Patent Application Publication No. H11-101913

### DISCLOSURE OF THE INVENTION

### Problems Solved by the Invention

However, even when the technology recited in Patent Document 1 is applied, there is a problem in that the stray light that enters with a large incident angle is not transmitted through the filter. For example, FIG. 9 shows the spectral transmittance characteristics of a high pass filter that comprises a multilayer film that has a film configuration (shown in Table 2) that is formed on glass. Although the characteristics are improved compared with those in FIG. 8, it can be seen that the transmittance of 1,310 nm light is approximately 2% at an incident angle of 60°, and reaches approximately 30% at an incident angle of 80°.

TABLE 2

| Layer Substance | n | nm | nd |
|---|---|---|---|
| air | 1 | | |
| Nb₂O₅ | 2.22 | 126.47 | 280.7634 |
| SiO₂ | 1.45 | 85.17 | 137.9965 |
| Nb2O5 | 2.22 | 252.95 | 561.549 |
| SiO2 | 1.45 | 95.17 | 137.9965 |
| Nb2O5 | 2.22 | 252.95 | 561.549 |
| SiO2 | 1.45 | 95.17 | 137.9965 |
| Nb2O5 | 2.22 | 252.95 | 561.549 |
| SiO2 | 1.45 | 95.17 | 137.9965 |
| Nb2O5 | 2.22 | 252.95 | 561.549 |
| SiO2 | 1.45 | 95.17 | 137.9965 |
| Nb2O5 | 2.22 | 252.95 | 561.549 |
| SiO2 | 1.45 | 95.17 | 137.9965 |
| Nb2O5 | 2.22 | 252.95 | 561.549 |
| SiO2 | 1.45 | 95.17 | 137.9965 |
| Nb2O5 | 2.22 | 252.95 | 561.549 |
| SiO2 | 1.45 | 95.17 | 137.9965 |
| Nb2O5 | 2.22 | 252.95 | 561.549 |
| SiO2 | 1.45 | 95.17 | 137.9965 |
| Nb2O5 | 2.22 | 252.95 | 561.549 |
| SiO2 | 1.45 | 95.17 | 137.9965 |
| Nb2O5 | 2.22 | 252.95 | 561.549 |
| SiO2 | 1.45 | 95.17 | 137.9965 |
| Nb2O5 | 2.22 | 252.95 | 561.549 |
| SiO2 | 1.45 | 95.17 | 139.9965 |
| Nb2O5 | 2.22 | 252.95 | 561.549 |
| SiO2 | 1.45 | 95.17 | 137.9965 |
| Nb2O5 | 2.22 | 252.95 | 561.549 |
| SiO2 | 1.45 | 95.17 | 137.9965 |
| Nb2O5 | 2.22 | 252.95 | 561.549 |
| SiO2 | 1.45 | 95.17 | 137.9965 |
| Nb2O5 | 2.22 | 252.95 | 561.549 |
| SiO2 | 1.45 | 95.17 | 137.9965 |
| Nb2O5 | 2.22 | 252.95 | 561.549 |
| SiO2 | 1.45 | 95.17 | 137.9965 |
| Nb2O5 | 2.22 | 252.95 | 561.549 |
| SiO2 | 1.45 | 95.17 | 137.9965 |
| Nb2O5 | 2.22 | 252.95 | 561.549 |
| SiO2 | 1.45 | 95.17 | 137.9965 |
| Nb2O5 | 2.22 | 252.95 | 561.549 |
| SiO2 | 1.45 | 95.17 | 137.9965 |
| Nb2O5 | 2.22 | 252.95 | 561.549 |
| SiO2 | 1.45 | 95.17 | 137.9965 |
| Nb2O5 | 2.22 | 252.95 | 561.549 |
| SiO2 | 1.45 | 95.17 | 137.9965 |
| Nb2O5 | 2.22 | 252.95 | 561.549 |
| SiO2 | 1.45 | 95.17 | 137.9965 |
| Nb2O5 | 2.22 | 252.95 | 561.549 |
| SiO2 | 1.45 | 95.17 | 137.9965 |
| Nb₂O₅ | 2.22 | 126.47 | 280.7634 |
| glass | 1.56 | | |

The present invention considers these circumstances, and it is an object of the present invention to provide a dichroic filter that tends not to transmit stray light, even if the incident angle of the stray light is large.

### Means for Solving the Problems

A first means for achieving the abovementioned object is a dichroic filter that has a filter, which comprises two types of multilayer films formed on one or both sides of a substrate, a transmittance, which is less than a design value, for light of a first wavelength that impinges the filter at a design working angle, and a transmittance, which is greater than that of light of the first wavelength, for light of a second wavelength, which is longer than the first wavelength, that impinges the filter at the design working angle, wherein the filter that comprises the multilayer films comprises a low pass filter part and a high pass filter part; for incident light that impinges the filter at the design working angle, the low pass filter part has a cutoff frequency that is between the frequency that corresponds to the first wavelength and the frequency that corresponds to the second wavelength; for incident light that impinges the filter at the design working angle, the high pass filter part has a cutoff frequency that is lower than the frequency that corresponds to the second wavelength; and because of a shift in the spectral transmittance characteristics of the filter as a result of light beams that impinge the filter at incident angles that are larger than the design working angle, for incident light that impinges at incident angles that are larger than the design working angle, the high pass filter part has a cutoff frequency that is greater than or equal to the frequency that corresponds to the first wavelength when the transmittance of the low pass filter part exceeds the design value for incident light of the first wavelength that impinges at incident angles that are larger than the design working angle; as a result, the transmittance of incident light of the first wavelength that impinges at incident angles that exceed the design value falls below the design value.

A second means for solving the abovementioned problem is a dichroic filter that has a filter, which comprises two types of multilayer films formed on one or both sides of a substrate, a transmittance, which is less than a design value, for light of a first wavelength that impinges the filter at a design working angle, and a transmittance, which is greater than that of light of the first wavelength, for light of a second wavelength, which is longer than the first wavelength, that impinges the filter at the design working angle, wherein the filter that comprises the multilayer films comprises a low pass filter part and a bandpass filter part; for incident light that impinges the filter at the design working angle, the low pass filter part has a cutoff frequency that is between the frequency that corresponds to the first wavelength and the frequency that corresponds to the second wavelength; for incident light that impinges the filter at the design working angle, the bandpass filter part transmits light of the second wavelength and has a cutoff frequency on the low frequency side that is lower than the frequency that corresponds to the second wavelength; and because of a shift in the spectral transmittance characteristics of the filter as a result of light beams that impinge the filter at incident angles that are larger than the design working angle, for incident light that impinges at incident angles that are larger than the design working angle, the bandpass filter part has a cutoff frequency on the low frequency side that is greater than or equal to the frequency that corresponds to the first wavelength when the transmittance of the low pass filter part exceeds the design value for incident light of the first wavelength that impinges at incident angles that are larger than the design working angle; as a result, the transmittance of incident light of the first wavelength that impinges at incident angles that exceed the design value falls below the design value.

A third means for solving the abovementioned problem is a dichroic filter that has a filter, which comprises two types of multilayer films formed on one or both sides of a substrate, a transmittance, which is less than a design value, for light of a first wavelength that impinges the filter at a design working angle, and a transmittance, which is greater than that of light of the first wavelength, for light of a second wavelength, which is longer than the first wavelength, that impinges the filter at the design working angle, wherein the filter that comprises the multilayer films comprises a bandpass filter part and a high pass filter part; for incident light that impinges the filter at the design working angle, the bandpass filter part transmits light of the second wavelength and has a cutoff frequency on the high frequency side that is between the frequency that corresponds to the first wavelength and the frequency that corresponds to the second wavelength; for incident light that impinges the filter at the design working angle, the high pass filter part has a cutoff frequency that is lower than the frequency that corresponds to the second wavelength; and because of a shift in the spectral transmittance characteristics of the filter as a result of light beams that impinge the filter at incident angles that are larger than the design working angle, for incident light that impinges at incident angles that are larger than the design working angle, the high pass filter part has a cutoff frequency that is greater than or equal to the frequency that corresponds to the first wavelength when the transmittance of the bandpass filter part exceeds the design value for incident light of the first wavelength that impinges at incident angles that are larger than the design working angle; as a result, the transmittance of incident light of the first wavelength that impinges at incident angles that are larger than the design working angle falls below the design value.

A fourth means for solving the abovementioned problem is a dichroic filter that has a filter, which comprises two types of multilayer films formed on one or both sides of a substrate, a transmittance, which is less than a design value, for light of a first wavelength that impinges the filter at a design working angle, and a transmittance, which is greater than that of light of the first wavelength, for light of a second wavelength, which is longer than the first wavelength, that impinges the filter at the design working angle, wherein the filter that comprises the multilayer films comprises bandpass filters, the spectral transmittance characteristics of which change differently with respect the incident angle; for incident light that impinges the filter at the design working angle, one of the filters, which is a first bandpass filter, transmits light of the second wavelength and has a cutoff frequency on the high frequency side that is between the frequency that corresponds to the first wavelength and the frequency that corresponds to the second wavelength; for incident light that impinges the filter at the design working angle, the other filter, which is a second bandpass filter, transmits light of the second frequency and has a cutoff frequency on the low frequency side that is lower than the frequency that corresponds to the second wavelength; and because of a shift in the spectral transmittance characteristics of the filter as a result of light beams that impinge the filter at incident angles that are larger than the design working angle, for incident light that impinges obliquely, the second bandpass filter has a cutoff frequency on the low frequency side that is greater than or equal to the frequency that corresponds to the first wavelength when the transmittance of the first bandpass filter exceeds the design value for incident light of the first wavelength that impinges at incident angles that are larger than the design working angle; as a result, the transmittance of incident light of the first wavelength that impinges at incident angles that are larger than the design working angle falls below the design value.

### EFFECTS OF THE INVENTION

According to the present invention, it is possible to provide a dichroic filter that tends not to transmit stray light, even if the incident angle of the stray light is large.

### BRIEF DESCRIPTION OF THE DRAWINGS

FIG. 1 explains the principle of the present invention.

FIG. 2 is a schematic drawing that shows the configuration of a dichroic filter according to an embodiment of the present invention.

FIG. 3 is a schematic drawing that shows the spectral transmittance characteristics of a first multilayer film filter 2 and a second multilayer film filter 3 according to a first embodiment of the present invention.

FIG. 4 is a schematic drawing that shows the spectral transmittance characteristics of the first multilayer film filter 2 and the second multilayer film filter 3 according to a second embodiment of the present invention.

FIG. 5 is a schematic drawing that shows the spectral transmittance characteristics of the first multilayer film filter 2 and the second multilayer film filter 3 according to a third embodiment of the present invention.

FIG. 6 is a schematic drawing that shows the spectral transmittance characteristics of the first multilayer film filter 2 and the second multilayer film filter 3 according to a fourth embodiment of the present invention.

FIG. 7 shows the spectral transmittance characteristics of the dichroic filter according to a working example of the present invention.

FIG. 8 shows the spectral transmittance characteristics of a conventional high pass filter.

FIG. 9 shows the spectral transmittance characteristics of an improved, conventional high pass filter.

### EXPLANATION OF SYMBOLS

1 Transparent substrate
2 First multilayer film filter
3 Second multilayer film filter

### DETAILED DESCRIPTION OF THE PREFERRED EMBODIMENTS

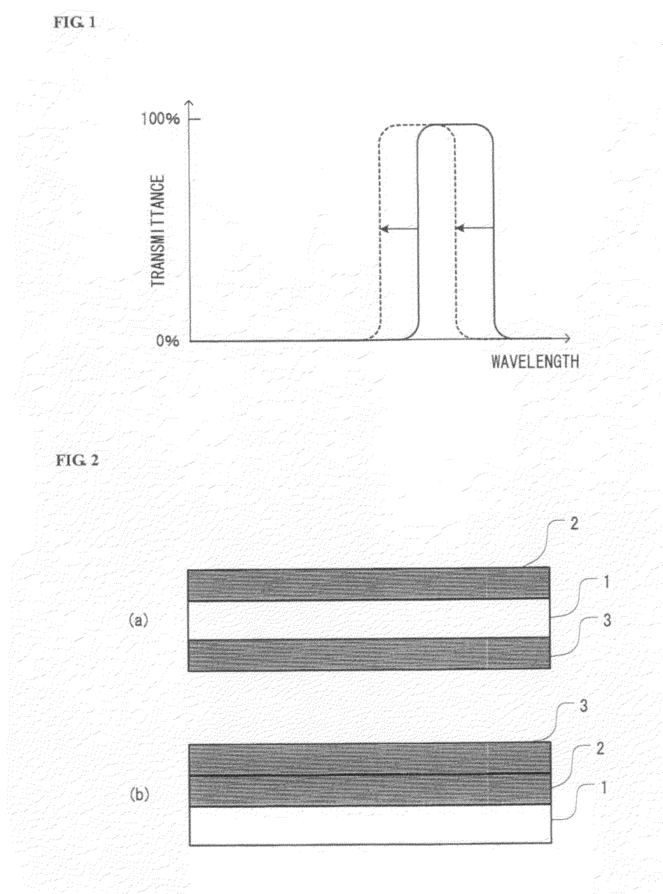

The following explains the embodiments of the present invention, but first the principle of the present invention will be explained referencing FIG. 1. FIG. 1 schematically shows the spectral transmittance characteristics of a multilayer film filter that is formed by alternately layering a high-refractive-index substance and a low-refractive-index substance. The central incidence angle when this multilayer film filter is used is 0°. The solid line shows the spectral transmittance characteristics when the incident angle is 0°, and the broken line shows the spectral transmittance characteristics for oblique incident light.

As shown in the figure, when the incident angle is no longer 0°, the curve that indicates the spectral transmittance characteristics shifts to the short wavelength side. The amount of shift increases as the incident angle increases. In addition, as described in Patent Document 1, the greater the ratio of the optical film thickness of the high-refractive-index substance (the product of the real film thickness and the refractive index) to the optical film thickness of the low-refractive-index substance becomes, the smaller the amount of shift becomes; conversely, the smaller the ratio becomes, the larger the amount of shift becomes. The present invention takes advantage of this property.

FIG. 2 is a schematic drawing that shows the configuration of a dichroic filter according to an embodiment of the present invention. In a first example (a), a first multilayer film filter 2 is formed on one side of a transparent substrate 1, e.g., glass, and a second multilayer film filter 3 is formed on the other side. In a second example (b), the first multilayer film filter 2 is formed on the transparent substrate 1, e.g., glass, and the second multilayer film filter 3 is formed thereon. Both examples have equivalent operational advantages. Furthermore, the dichroic filter may comprise other multilayer films in addition to the first multilayer film filter 2 and the second multilayer film filter 3.

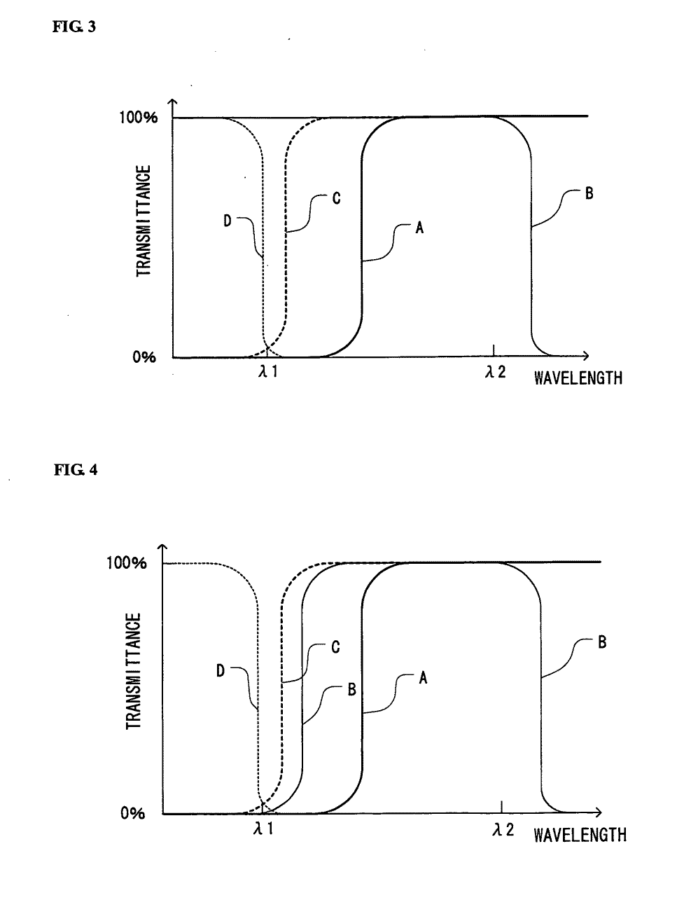

FIG. 3 is a schematic drawing that shows the spectral transmittance characteristics of the first multilayer film filter 2 and the second multilayer film filter 3 according to a first embodiment of the present invention. In the present embodiment, the first multilayer film filter 2 is a low pass filter and the second multilayer film filter 3 is a high pass filter. A indicates the spectral transmittance characteristics when the incident angle with respect to the first multilayer film filter 2 is 0°, B indicates the spectral transmittance characteristics when the incident angle with respect to the second multilayer film filter 3 is 0°, C indicates the spectral transmittance characteristics when the incident angle with respect to the first multilayer film filter 2 is larger than its design incident angle, and D indicates the spectral transmittance characteristics when the incident angle with respect to the second multilayer film filter 3 is greater than its design incident angle.

In the embodiments below, including the present embodiment, the ratio of the optical film thickness of the high-refractive-index substance and the optical film thickness of the low-refractive-index substance of the first multilayer film filter 2 is more than large enough (preferably 2:1 or greater), and the ratio of the optical film thickness of the high-refractive-index substance to the optical film thickness of the low-refractive-index substance of the second multilayer film filter 3 is more than small enough (preferably less than 1:1). Accordingly, the amount of shift in the spectral transmittance curve of the second multilayer film filter 3 is far greater than that of the first multilayer film filter 2.

In addition, the cutoff frequency of the first multilayer film filter 2 is between the frequency that corresponds to λ1, which is the wavelength to be reflected, and the frequency that corresponds to λ2, which is the wavelength to be transmitted; furthermore, the cutoff frequency of the second multilayer film filter 3 is lower than the frequency that corresponds to λ2.

Because the design incident angle is not 0°, the spectral transmittance curve shifts as discussed above; namely, in the case of the first multilayer film filter 2, the spectral transmittance curve shifts from the characteristic A when the incident angle is 0° to C when the incident angle is greater than the design incident angle. As a result, transmittance increases at the wavelength λ1, which exceeds the permissible value in the design. Incidentally, in the case of the second multilayer film filter 3 as well, the spectral transmittance curve shifts, i.e., the spectral transmittance curve shifts from the characteristic B when the incident angle is 0° to D when the incident angle is greater than the design incident angle.

As discussed above, the ratio between the optical film thickness of the high-refractive-index substance and the optical film thickness of the low-refractive-index substance of the first multilayer film filter 2 is more than large enough, and the ratio between the optical film thickness of the high-refractive-index substance and the optical film thickness of the low-refractive-index substance of the second multilayer film filter 3 is more than small enough; as a result, the amount of shift in the spectral transmittance curve of the second multilayer film filter 3 is far greater than that of the first multilayer film filter 2; consequently, the cutoff frequency of the second multilayer film filter 3 is higher than the frequency that corresponds to λ1.

The spectral transmittance characteristics of the dichroic filter as a whole are calculated by multiplying the values indicated by the curve C and the curve D at each frequency, and therefore the transmittance at the wavelength λ1 is extremely small and falls within the range permitted by the design. Furthermore, as can be seen clearly from FIG. 3, the transmittance of the dichroic filter as a whole at any incident angle that is larger than the design incident angle approaches 0 even with light of the wavelength λ2; however, there is no need to take the stray light into consideration because the light of the wavelength λ2 impinges perpendicularly, and therefore there are no problems even if the transmittance at an incident angle that is greater than the design incidence angle is 0.

The present embodiment uses a bandpass filter instead of a high pass filter as the second multilayer film filter 3, but has the same operational advantages as the first embodiment in that the cutoff frequency on the high frequency side of the bandpass filter is higher than the frequency that corresponds to λ2, and the cutoff frequency on the low frequency side is lower than the frequency that corresponds to λ2; furthermore, the bandpass filter may be the same as the high pass filter in the first embodiment. This embodiment shall be the second embodiment. The spectral transmittance characteristics for this case are shown in FIG. 4 wherein the symbols are the same as those shown in FIG. 3. In this case, the cutoff frequency on the low frequency side of the bandpass filter is higher than the frequency that corresponds to λ1 because of the wavelength shift at incident angles that are larger than the design incidence angle; as a result, light with a wavelength of λ1 is blocked by the second multilayer film filter 3, which is a bandpass filter, at incident angles that are larger than the design incidence angle; ultimately, the filter, which functions as a dichroic filter, is capable of reducing the transmittance of light with a wavelength of λ1 to a value that is less than the design value.

In addition, the same effect is obtained even if a bandpass filter instead of a low pass filter is used as the first multilayer film filter 2. In this case, the cutoff frequency on the high frequency side of the bandpass filter is between the frequency that corresponds to λ1 and the frequency that corresponds to λ2, and the cutoff frequency on the low frequency side is lower than the frequency that corresponds to λ2. Other aspects of the present embodiment are the same as those in the first embodiment. This embodiment shall be the third embodiment.

The spectral transmittance characteristics in this case are shown in FIG. 5, wherein the symbols are the same as those shown in FIG. 3. In this case, the cutoff frequency on the low frequency side of the bandpass filter is higher than the frequency that corresponds to λ1 because of the wavelength shift at incident angles that are larger than the design incidence angle; as a result, light with the wavelength of λ1 is blocked by the first multilayer film filter 3, which is a low filter, at incident angles that are greater than the design incidence angle; ultimately, the filter, which functions as a dichroic filter, can reduce the transmittance of light with a wavelength of λ1 to a value that is less than the design value. Furthermore, the same effects are obtained even if bandpass filters are used as the first multilayer film filter 2 and the second multilayer film filter 3. In this case, the cutoff frequency on the high frequency side of the bandpass filter that corresponds to the first multilayer film filter 2 is between the frequency that corresponds to λ1 and the frequency that corresponds to λ2, and the cutoff frequency on the low frequency side is lower than the frequency that corresponds to λ2. Furthermore, the cutoff frequency on the high frequency side of the bandpass filter that corresponds to the second multilayer film filter 3 is higher than the frequency that corresponds to λ2, and the cutoff frequency on the low frequency side is lower than the frequency that corresponds to λ2. Other aspects of the present embodiment are the same as those in the first embodiment. This embodiment shall be the fourth embodiment.

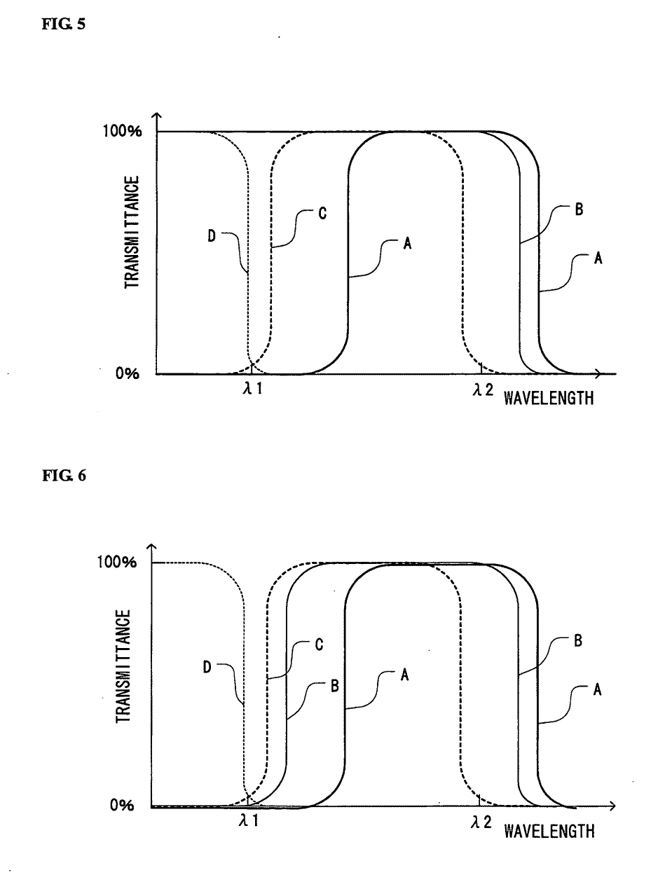

The spectral transmittance characteristics in this case are shown in FIG. 6, wherein the symbols are the same as those shown in FIG. 3. In this case, the cutoff frequency on the low frequency side of the bandpass filter that corresponds to the second multilayer film filter 3 is higher than the frequency that corresponds to λ1 because of the wavelength shift at incident angles that are larger than the design incidence angle; as a result, light of a wavelength of λ1 is also blocked by the second multilayer film filter 3, which is a bandpass filter, at incident angles that are greater than the design incidence angle; ultimately, the filter, which functions as a dichroic filter, can reduce the transmittance of light with a wavelength of λ1 to a value that is less than the design value.

Furthermore, the design incidence angle depends on the application of the multilayer film filter 3, but is preferably set in the vicinity of 0-15°.

### WORKING EXAMPLES

A dichroic filter was prepared by sequentially layering a low pass filter, which was formed by alternately layering SiO₂ (a low-refractive-index substance) and Nb₂O₅ (a high-refractive-index substance), an adjustment layer, and a high pass filter, which was formed by alternately layering SiO₂ (a low-refractive-index substance) and Nb₂O₅ (a high-refractive-index substance), on a glass substrate.

The low pass filter was prepared by: first forming a film of SiO₂ on the surface of the glass substrate with a thickness of 239.1 nm (optical film thickness of 346.7 nm); layering 29 layers thereon, wherein each layer comprised a pair of films, i.e., an Nb₂O₅ film and an SiO₂ film (the Nb₂O₅ film had a thickness of 62.5 nm and an optical film thickness of 138.8 nm, and the SiO₂ film had a thickness of 478.1 nm and an optical film thickness of 693.); and then layering thereon one layer of an Nb₂O₅ film with a thickness of 62.5 nm and an optical film thickness of 138.8 nm. The adjustment layer was layered thereon by successively forming an SiO₂ film with a thickness of 239.1 nm and an optical film thickness of 346.7 nm, and an Nb₂O₅ film with a thickness of 126.5 nm and an optical film thickness of 280.8 nm. The high pass filter was prepared by layering 24 layers, wherein each layer comprised a pair of films, i.e., an SiO₂ film and an Nb₂O₅ film (the SiO₂ film had a thickness of 95.2 nm and an optical film thickness of 138.0 nm, and the Nb₂O₅ film had a thickness of 253.0 nm and an optical film thickness of 561.5 nm). This high pass filter was layered on the above-mentioned adjustment layer.

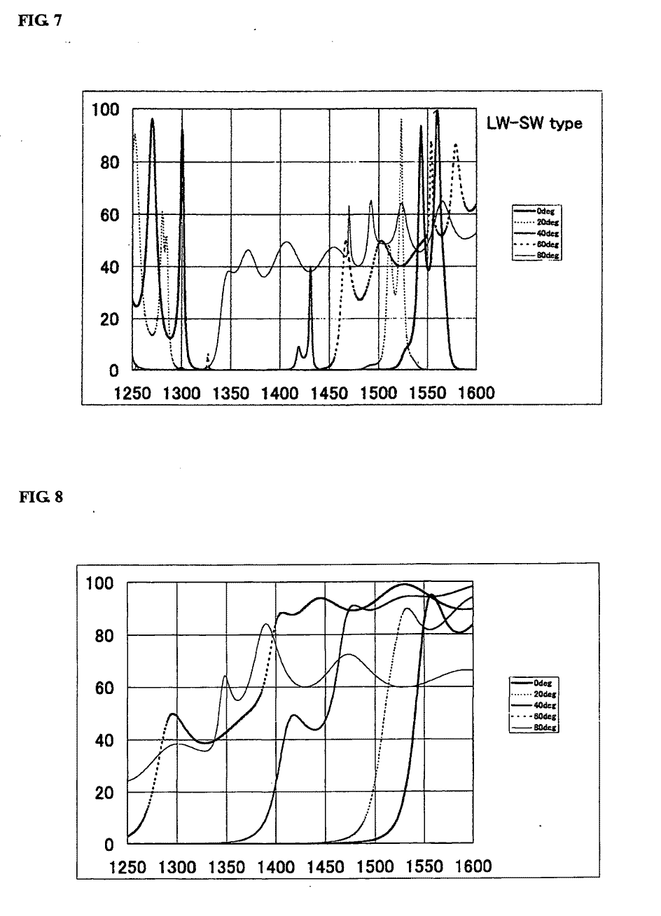

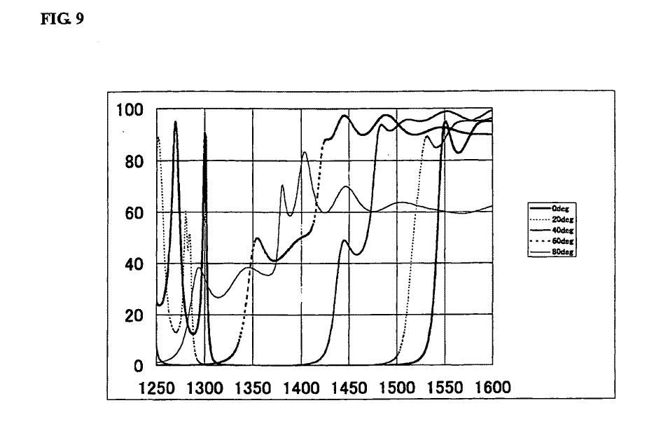

The spectral transmittance characteristics of this dichroic filter are shown in FIG. 7. In FIG. 7, the abscissa represents the wavelength (nm). At an incident angle of 0°, the transmittance of light of a wavelength of 1310 nm is virtually zero, and the transmittance of light of a wavelength of 1560 nm is close to 100%. Furthermore, the transmittance of light of a wavelength of 1310 nm is maintained at substantially zero even when the incident angle is 80°.

What is claimed is:

1. A dichroic filter that has a filter, which comprises two types of multilayer films formed on one or both sides of a substrate, a transmittance, which is less than a design value, for light of a first wavelength that impinges the filter at a design working angle, and a transmittance, which is greater than that of light of the first wavelength, for light of a second wavelength, which is longer than the first wavelength, that impinges the filter at the design working angle, wherein
the filter that comprises the multilayer films comprises a low pass filter part and a high pass filter part;
for incident light that impinges the filter at the design working angle, the low pass filter part has a cutoff frequency that is between the frequency that corresponds to the first wavelength and the frequency that corresponds to the second wavelength;
for incident light that impinges the filter at the design working angle, the high pass filter part has a cutoff frequency that is lower than the frequency that corresponds to the second wavelength; and
because of a shift in the spectral transmittance characteristics of the filter as a result of light beams that impinge the filter at incident angles that are larger than the design working angle, for incident light that impinges at incident angles that are larger than the design working angle, the high pass filter part has a cutoff frequency that is greater than or equal to the frequency that corresponds to the first wavelength when the transmittance of the low pass filter part exceeds the design value for incident light of the first wavelength that impinges at incident angles that are larger than the design working angle; as a result, the transmittance of incident light of the first wavelength that impinges at incident angles that exceed the design value falls below the design value.

2. A dichroic filter that has a filter, which comprises two types of multilayer films formed on one or both sides of a substrate, a transmittance, which is less than a design value, for light of a first wavelength that impinges the filter at a design working angle, and a transmittance, which is greater than that of light of the first wavelength, for light of a second wavelength, which is longer than the first wavelength, that impinges the filter at the design working angle, wherein
the filter that comprises the multilayer films comprises a low pass filter part and a bandpass filter part;
for incident light that impinges the filter at the design working angle, the low pass filter part has a cutoff frequency that is between the frequency that corresponds to the first wavelength and the frequency that corresponds to the second wavelength;
for incident light that impinges the filter at the design working angle, the bandpass filter part transmits light of the second wavelength and has a cutoff frequency on the low frequency side that is lower than the frequency that corresponds to the second wavelength; and
because of a shift in the spectral transmittance characteristics of the filter as a result of light beams that impinge the filter at incident angles that are larger than the design working angle, for incident light that impinges at incident angles that are larger than the design working angle, the bandpass filter part has a cutoff frequency on the low frequency side that is greater than or equal to the frequency that corresponds to the first wavelength when the transmittance of the low pass filter part exceeds the design value for incident light of the first wavelength that impinges at incident angles that are larger than the design working angle; as a result, the transmittance of incident light of the first wavelength that impinges at incident angles that exceed the design value falls below the design value.

3. A dichroic filter that has a filter, which comprises two types of multilayer films formed on one or both sides of a substrate, a transmittance, which is less than a design value, for light of a first wavelength that impinges the filter at a design working angle, and a transmittance, which is greater than that of light of the first wavelength, for light of a second wavelength, which is longer than the first wavelength, that impinges the filter at the design working angle, wherein
the filter that comprises the multilayer films comprises a bandpass filter part and a high pass filter part;
for incident light that impinges the filter at the design working angle, the bandpass filter part transmits light of the second wavelength and has a cutoff frequency on the high frequency side that is between the frequency that corresponds to the first wavelength and the frequency that corresponds to the second wavelength;
for incident light that impinges the filter at the design working angle, the high pass filter part has a cutoff frequency that is lower than the frequency that corresponds to the second wavelength; and
because of a shift in the spectral transmittance characteristics of the filter as a result of light beams that impinge the filter at incident angles that are larger than the design working angle, for incident light that impinges at incident angles that are larger than the design working angle, the high pass filter part has a cutoff frequency that is greater than or equal to the frequency that corresponds to the first wavelength when the transmittance of the bandpass filter part exceeds the design value for incident light of the first wavelength that impinges at incident angles that are larger than the design working angle; as a result, the transmittance of incident light of the first wavelength that impinges at incident angles that are larger than the design working angle falls below the design value.

4. A dichroic filter that has a filter, which comprises two types of multilayer films formed on one or both sides of a substrate, a transmittance, which is less than a design value, for light of a first wavelength that impinges the filter at a design working angle, and a transmittance, which is greater than that of light of the first wavelength, for light of a second wavelength, which is longer than the first wavelength, that impinges the filter at the design working angle, wherein
the filter that comprises the multilayer films comprises bandpass filters, the spectral transmittance characteristics of which change differently with respect the incident angle;
for incident light that impinges the filter at the design working angle, one of the filters, which is a first bandpass filter, transmits light of the second wavelength and has a cutoff frequency on the high frequency side that is between the frequency that corresponds to the first wavelength and the frequency that corresponds to the second wavelength;
for incident light that impinges the filter at the design working angle, the other filter, which is a second bandpass filter, transmits light of the second frequency and has a cutoff frequency on the low frequency side that is lower than the frequency that corresponds to the second wavelength; and
because of a shift in the spectral transmittance characteristics of the filter as a result of light beams that impinge the filter at incident angles that are larger than the design working angle, for incident light that impinges obliquely, the second bandpass filter has a cutoff frequency on the low frequency side that is greater than or equal to the frequency that corresponds to the first wavelength when the transmittance of the first bandpass filter exceeds the design value for incident light of the first wavelength that impinges at incident angles that are larger than the design working angle; as a result, the transmittance of incident light of the first wavelength that impinges at incident angles that are larger than the design working angle falls below the design value.
